(19) United States
(12) Patent Application Publication
(10) Pub. No.: US 2018/0068775 A1
(43) Pub. Date: Mar. 8, 2018

(54) MAGNETIC POWDER AND INDUCTOR CONTAINING THE SAME

(71) Applicant: SAMSUNG ELECTRO-MECHANICS CO., LTD., Suwon-si (KR)

(72) Inventors: Soon Kwang KWON, Suwon-si (KR); Jae Kwang KIM, Suwon-si (KR); Jung Wook SEO, Suwon-si (KR); Hyung Ho KIM, Suwon-si (KR); Young Seuck YOO, Suwon-si (KR); Young Sin KIM, Suwon-si (KR)

(21) Appl. No.: 15/648,686

(22) Filed: Jul. 13, 2017

(30) Foreign Application Priority Data
Sep. 7, 2016 (KR) 10-2016-0115000
Sep. 26, 2016 (KR) 10-2016-0123403

(51) Int. Cl. H01F 27/255; H01F 27/29

(52) U.S. Cl. CPC H01F 27/255; H01F 1/14733; H01F 27/29

(57) ABSTRACT

A magnetic powder includes an insulating layer formed of a polymer material which is directly coated on a powder particle core having magnetic properties. An inductor containing the same is also provided. The magnetic powder does not include a separate inorganic insulating layer between the powder particle core and the insulating layer, the insulating layer has a relatively uniform thickness, and a body formed using the magnetic powder does not contain a separate binder or curing agent, such that a high permeability and an excellent Q factor may be implemented.

### CROSS-REFERENCE TO RELATED APPLICATION(S)

This application claims benefit of priority to Korean Patent Applications No. 10-2016-0115000, filed on Sep. 7, 2016 and No. 10-2016-0123403, filed on Sep. 26, 2016 in the Korean Intellectual Property Office, the disclosures of which are incorporated herein by reference in their entireties.

### BACKGROUND

### 1. Field

The present disclosure relates to a magnetic powder and an inductor containing the same.

### 2. Description of Related Art

In order to continue the recent trend toward miniaturization and multi-functionality of electronic products, miniaturization of an inductor element is needed. Additionally, in portable devices such as smartphones, stronger currents are required due to diversification of functions. The portable electronic components supply operational power having various voltages required by different internal circuits using a power supply circuit such as a direct current (DC)-DC converter. In an inductor used in a DC circuit, a high permeability material having a property capable of suppressing magnetic saturation and having high inductance is structurally required.

Meanwhile, an example of the inductor includes a mold type inductor, formed by molding a metal powder, using a mold as illustrated in FIG. 1A, a winding type inductor, illustrated in FIG. 1B, used in a component requiring slimness and lightness such as the smartphone, and a thin film type inductor, illustrated in FIG. 1C.

In an effort to improve electrical properties of various types of inductors such as those described above, an attempt to produce a magnetic material having an excellent insulation property while having a high permeability has been variously conducted. As an example, a magnetic material obtained by coating a glass film on a surface of an alloy magnetic powder particle, and coating outer portions thereof with a thermosetting resin simultaneously serving as an insulating material and a binder, has been disclosed. However, in the case of using glass in order to improve thermal resistance and achieve a high insulation property, particularly when the magnetic powder is made of an alloy and heat impact is applied to a core, thermal stress may be generated, due to a difference in expansion coefficients between the alloy and the glass. As a result, cracks may occur on a surface of the glass. In addition, it is difficult to add coats of an insulating material uniformly to the glass coating, and, in every process for manufacturing the inductor, cracks may occur.

### SUMMARY

An aspect of the present disclosure describes a magnetic powder capable of providing a high permeability body and an inductor having excellent quality (Q) factor.

According to an aspect of the present disclosure, a magnetic powder may include an insulating layer containing a polymer material disposed on a surface of a powder particle core having magnetic properties, without an additional coating layer interposed therebetween.

According to another aspect of the present disclosure, an inductor may include a body containing the magnetic powder as described above, and external electrodes disposed on the body and electrically connected to at least one end portion of a coil embedded in the body.

### BRIEF DESCRIPTION OF DRAWINGS

The above and other aspects, features, and advantages of the present disclosure will be more clearly understood from the following detailed description when taken in conjunction with the accompanying drawings, in which:

FIGS. 1A through 1C illustrate various types of inductors;

FIG. 2 is a schematic cross-sectional view of a magnetic powder particle according to an exemplary embodiment;

FIG. 3 is a schematic cross-sectional view of an inductor according to another exemplary embodiment;

FIG. 4A illustrates an example of an enlarged view of region A of FIG. 3; and

FIG. 4B illustrates another example of the enlarged view of region A of FIG. 3.

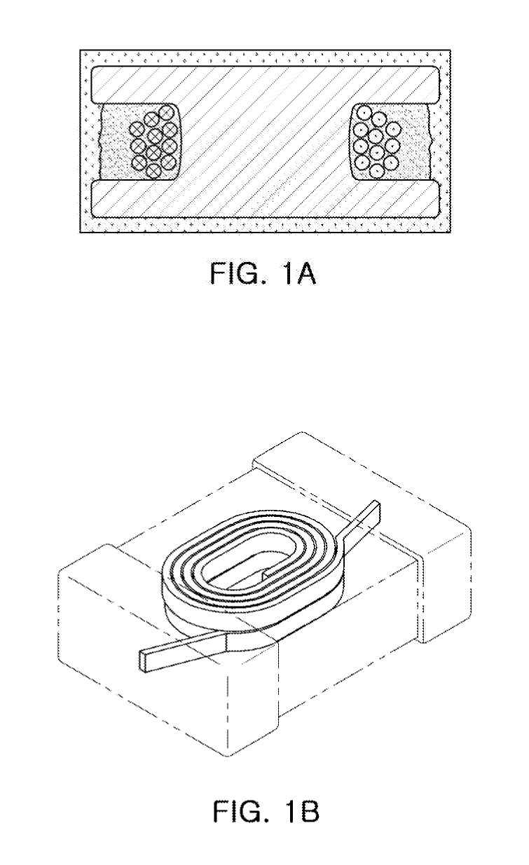

### DETAILED DESCRIPTION

Hereinafter, exemplary embodiments will be described in detail with reference to the accompanying drawings.

Hereinafter, a magnetic powder according to an exemplary embodiment, and an inductor containing the same, will be described, but the magnetic powder and the inductor are not necessarily limited thereto.

Magnetic Powder Particle

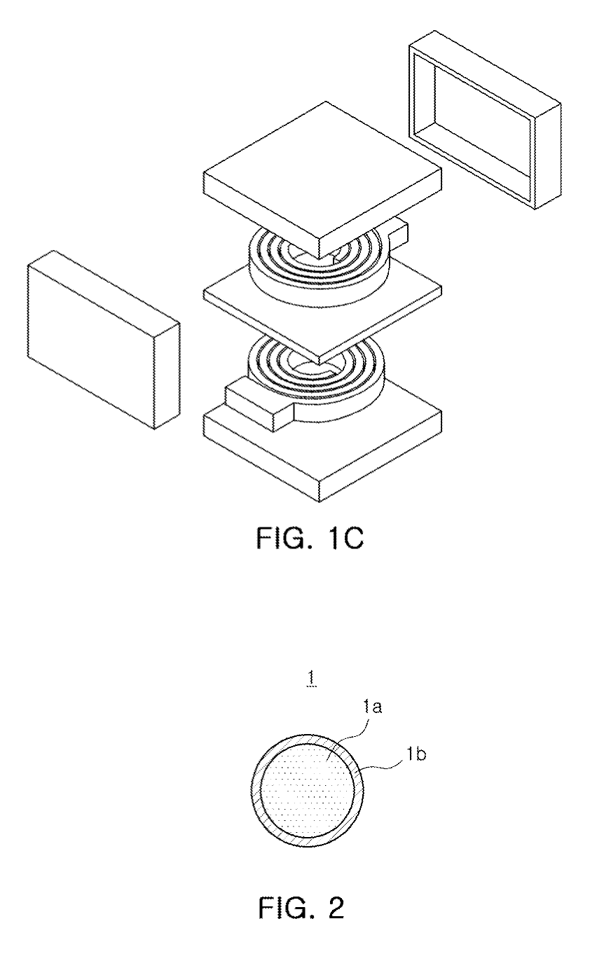

FIG. 2 is a schematic cross-sectional view of a magnetic powder particle according to an exemplary embodiment. Referring to FIG. 2, a magnetic powder particle 1 includes a powder particle core 1a having magnetic properties and an insulating layer 1b directly disposed on a surface of the powder particle core 1a. The insulating layer 1b is directly disposed on the surface of the powder particle core 1a, which means that the insulating layer 1b, formed of a polymer material, is directly coated on the surface of the powder particle core without an additional coating layer or other intervening layer.

As a material of the powder particle core 1a, any material may be used without limitation as long as it has magnetic properties. For example, the powder particle core may be formed of one or more selected from Fe, an Fe—Ni based alloy, an Fe—Si based alloy, an Fe—Si—Al based alloy, an Fe—Cr—Si based alloy, an Fe based amorphous alloy, an Fe based nanocrystalline alloy, a Co based amorphous alloy, an Fe—Co based alloy, an Fe—N based alloy, MnZn based ferrite, NiZn based ferrite, and the like.

A degree of freedom in selecting the material of the powder particle core 1a is large, which is an excellent advantage in view of material design.

An alloy used in an inductor subjected to oxidation treatment according to the related art has a limitation in that, in order to form a Cr oxide (Cr₂O₃) layer on a surface of the alloy, there is a need to use only an Fe—Si—Cr based powder containing Cr, which means that there is a limitation in improving permeability since the based powder material cannot be changed.

Since, in the magnetic powder according to the present disclosure, the insulating layer formed of the polymer material, which is a separate material, is disposed on the powder particle core 1a, there is no limitation in selecting the material of the powder particle core 1a, and various alloys capable of implementing a high permeability may be used.

The powder particle core 1a may have a substantially spherical shape, as illustrated in FIG. 2, or an oval shape. Alternatively, the powder particle core 1a may have various other shapes with a partially formed corner. The shape of the powder particle core 1a is not limited.

Meanwhile, a central portion and a surface portion of the powder particle core 1a have substantially the same composition as each other, which means that the surface of the powder particle core 1a is not subjected to a separate oxidation treatment, or the like. In a case in which the powder particle core 1a is formed of an alloy, the powder particle core 1a is naturally oxidized, and thus a predetermined oxide layer may be formed. However, an amount of the oxide layer may be significantly small, and the central portion and the surface portion of the powder particle core 1a may have substantially the same composition as each other.

Next, the insulating layer 1b, formed of the polymer material and coated on at least a portion of the surface of the powder particle core 1a, will be described. Referring to FIG. 2, the insulating layer 1b may be disposed on an outer peripheral surface of the powder particle core 1a at a uniform thickness. According to the related art, in order to maintain an insulation property of an alloy powder, strength of a product was maintained by forming an inorganic insulating layer using kaolin, MgO, talc, water glass, or the like, and then coating and curing a surface of the inorganic insulating layer with a polymer material, for example, an epoxy. However, in a case of the magnetic powder according to the related art, which has a double layer composed of the inorganic insulating layer as described above and an epoxy layer, a distance between a magnetic powder particle and another magnetic powder particle adjacent thereto is relatively increased, such that permeability may be decreased. In a case of increasing a particle size of the magnetic powder in order to secure permeability at an equivalent level, a quality (Q) value may be decreased.

Since the magnetic powder particle 1 according to the exemplary embodiment has a structure in which the insulating layer 1b formed of the polymer material is directly coated on the powder particle core 1a, the magnetic powder has a single insulating layer, which is definitely distinguished from the double insulating layer according to the related art, with no problem existing in the double insulating layer according to the related art. In particular, in accordance with the exemplary embodiment, the insulating layer 1b formed of the polymer material is directly coated on the powder particle core 1a such that the powder particle sore 1a does not contain an additional inorganic layer having a different composition from the composition of the powder particle core and disposed between the powder particle core and the insulating layer 1b.

The polymer material used in the insulating layer 1b is not particularly limited, but may preferably be a thermosetting resin. It is particularly preferable that the polymer material is an epoxy resin. The epoxy resin may be variously changed depending on characteristics of the magnetic powder to be required. For example, in a case in which a high-resistance insulation property is required, the epoxy resin may be an epoxy that does not include a benzene ring, and may be an epoxy generally used as a binder, but is not limited thereto.

The insulating layer 1b may be formed to have a relatively uniform thickness, depending on an exterior of the powder particle core 1a, and may have various thicknesses, depending on the required insulation property, but the insulating layer may generally have a thickness in the range of, preferably, 1.0 nm or more to 5.0 μm or less. When the thickness of the insulating layer 1a is thinner than 1.0 nm, it is difficult to secure a sufficient insulation property, and when the thickness thereof is thicker than 5.0 μm, a distance between magnetic powders adjacent to each other may be relatively increased, and thus, it may be difficult to secure a sufficient permeability.

In the current application, the thickness of the insulating layer is uniform, which means that a minimum thickness of the insulating layer is 1.0 nm, and a maximum thickness of the insulating layer is 5.0 μm. For example, even though the insulating layer disposed on the powder particle core does not have the same thickness, a thickness deviation is not over, at most, 1.0 nm to 5.0 μm. Even in a case in which the powder particle core does not have a spherical shape, the thickness of the insulating layer may be set as a distance from the surface of the powder particle core 1a to an outer surface of the insulating layer 1b on a straight line, extended from the center of gravity of the powder particle core 1a to the surface of the powder particle 1b.

Next, an example of a specific preparation method of the magnetic powder 1 will be described. However, preparation of the magnetic powder 1 according to the present disclosure is not limited by the preparation method to be described below, and the magnetic powder 1 is not limited to a magnetic powder prepared by a preparation method to be described below.

As a powder particle core material having magnetic properties, an alloy having a desired composition and content may be selected. Similarly, a polymer material capable of implementing a desired insulation property may be selected. The powder particle core 1a and the polymer material may be prepared so that a weight ratio of the polymer material, with respect to 100 wt % of the powder particle, is in a range of 1 wt % or more to 5.0 wt % or less, but the weight ratio may be suitably changed depending on physical properties of the polymer material. The powder particle core 1a and the polymer material prepared as described above may be dry-stirred and mixed, or wet-stirred and mixed, using a V-type mixer, balls, mills, beads mill, various rotary mixers, or the like. The mixing may be performed for 5 minutes to 200 hours. In a case of coating the polymer material on the magnetic powder using a wet-mixing method, unlike a dry-mixing method, there is a need to use a solvent. In a case in which the powder particles and the polymer material are wet-stirred and mixed, the magnetic powder particles may be dried using a fluidized-bed dryer, a spray dryer, or the like.

The magnetic powder obtained as described above may include the single insulating layer coated on the powder particle core 1a at a relatively uniform thickness, such that in a case in which the magnetic powder is used in a body of an inductor, to be described below, a high permeability and an excellent Q factor may be implemented.

Inductor

Next, an inductor containing the magnetic powder according to another exemplary embodiment will be described.

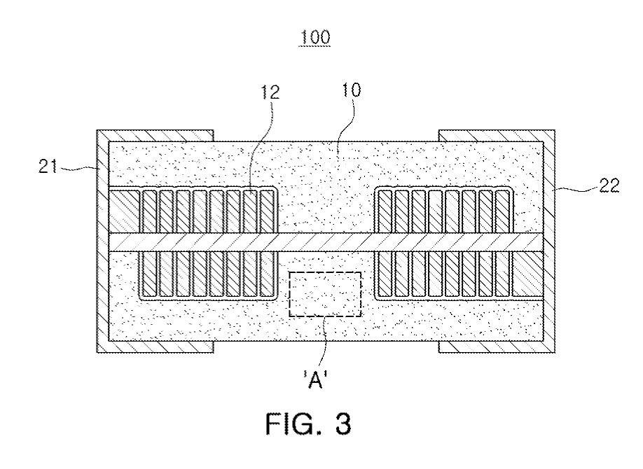

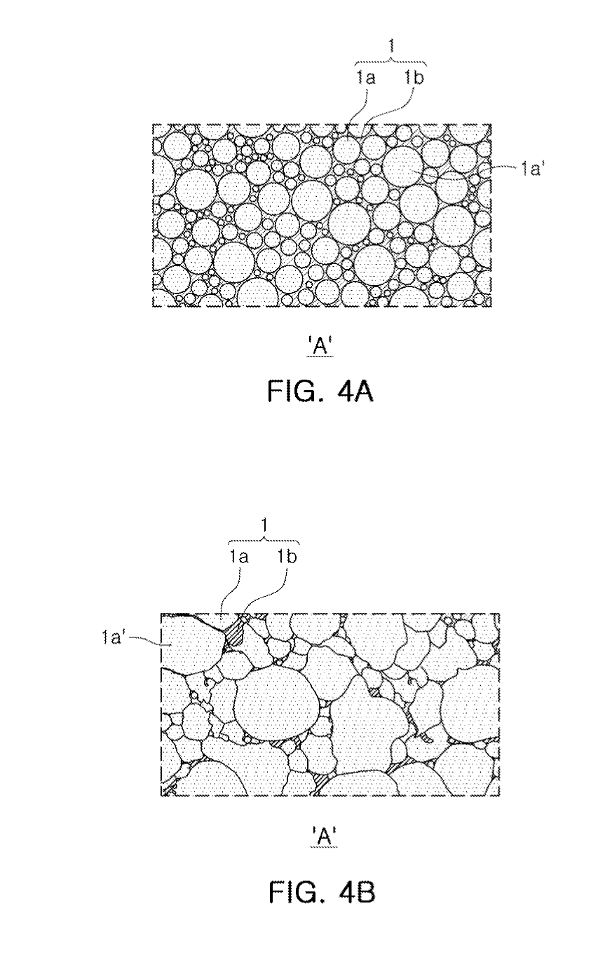

FIG. 3 is a schematic cross-sectional view of an inductor according to another exemplary embodiment, and FIGS. 4A and 45 illustrate examples of an enlarged view of region A of FIG. 3.

Referring to FIG. 3, an inductor 100 according to the exemplary embodiment may include a body 10 in which a coil 12 having two end portions is embedded, and first and second external electrodes 21 and 22 disposed on at least portions of an outer surface of the body 10 and connected to respective end portions of the coil 12.

The coil 12 embedded in the body may be a winding coil, a laminated coil, or a thin film coil, depending on a manufacturing method, and may be suitably selected depending on a design change. The coil may have a spiral shape or be a plane coil. A material of the coil is not limited as long as it has excellent conductivity. For example, the coil may be formed of one metal selected from gold (Au), silver (Ag), platinum (Pt), copper (Cu), nickel (Ni), palladium (Pd), aluminum (Al), titanium (Ti), and the like, or may be an alloy thereof.

The body 10 may contain the magnetic powder 1 described above, and will be described with reference to FIGS. 4A and 4B, which are enlarged views of region A of FIG. 3.

A configuration illustrated in FIG. 4B is substantially the same as that in FIG. 4A except for a degree of adjacency between magnetic powders in arrangement of the magnetic powders in the body or a shape of the magnetic powders. Therefore, hereinafter, the region A in the body of the inductor will be described, based on FIG. 4A, and FIG. 4B will be described based on a difference from FIG. 4A.

Referring to FIG. 4A, a powder particle core 1a in the magnetic powder 1 may be disposed to be adjacent to another powder particle core 1a′ by a distance of the overlap of the insulating layer 1b, disposed on a surface of the powder particle core 1a.

Altogether, it may be considered that the body 10 contains the powder particle cores 1a in a matrix formed by a connection between the insulating layers 1b coated on the powder particle cores 1a. This means that the body 10 does not contain a separate curing agent, a residue of a binder, and the like, except for the polymer material contained in the insulating layer 1b.

Although a case in which the powder particle core 1a has a substantially spherical shape is illustrated in FIG. 4A, the powder particle core material may be configured by mixing two or more kinds of powder particle cores, of which shapes and average particle sizes are different from each other. In a case of using powder particle cores 1a having different crystal particle sizes, the permeability may be increased by increasing a filling density of the magnetic powder in the body 10. In addition, the shape of the powder particle core 1a may be changed. For example, in a case in which the powder particle has a flake shape, of which a long axis and a short axis are distinguished from each other, a density of a magnetic flux generated from the coil 12 may be improved.

In relation to a volume ratio between the powder particle core 1a contained in the body 10 and the insulating layer 1b coated on the surface of the powder particle core 1a, it is preferable that a volume ratio of the insulating layer 1b is in a range of 3 vol % to 15 vol %, based on 100 vol % of the powder particle core 1a. In a case in which the volume ratio of the insulating layer is less than 3 vol %, the insulation property may not be sufficiently exhibited, and in a case in which the volume ratio of the insulating layer is greater than 15 vol %, it may be difficult to secure a sufficient permeability.

Next, a function of the insulating layer 1b in the body will be described in detail.

First, the insulating layer 1b, coated on the powder particle core 1a, may serve as the insulating layer insulating the magnetic powder particles from each other, so that electricity is not conducted. The insulating layer 1b, having a relatively thin and uniform thickness and having the insulation property, may be implemented as compared to a case in which an organic insulating layer is coated again on the inorganic insulating layer according to the related art.

Further, the insulating layer 1b coated on the powder particle core 1a may serve as a curing agent fixing powder particles to each other through thermal treatment and imparting strength of the magnetic powder. This means that, in a case in which, during forming of the body, a mixed powder of the magnetic powder is cured, the magnetic powders are cured through the insulating layer 1b being directly coated on the powder particle core 1a without adding a separate curing agent, for example, phenol, acid anhydride, amine, or the like.

Then the insulating layer 1b coated on the powder particle core 1a may serve as a binder. Since the insulating layer 1b may have functions of a binder resin, as well as an insulating function, a separate binder resin is not necessarily required. Of course, a binder resin may be added to the body, but in a case in which the binder resin is not added, the permeability may be improved, and a core loss may be decreased.

Next, referring to FIG. 4B, a powder particle core 1a in the magnetic powder 1 may be disposed to be adjacent to another powder particle core 1a′ by the insulating layer 1b being disposed on a surface of the powder particle core 1a, similar to FIG. 4A.

However, a distance between the powder particle cores 1a and 1a′ of the magnetic powders adjacent to each other in FIG. 4B is shorter than that in FIG. 4A. A degree of adjacency may be a degree at which the powder particle cores 1a and 1a′, independent from each other, form a substantially single powder particle. In this case, a single powder particle core is formed, which means that individual particle sizes of different powder particle materials in a cured body cannot be distinguished by the naked eye. Of course, a distance between powder particles in the body of a single inductor may be various, and the distances may be multiply and comprehensively determined by various factors such as a temperature applied thereto in a curing process, a curing pressure, a thickness of the insulation layer, and the like.

As described above, the magnetic powder 1 contained in the body includes the single insulating layer 1b, and the insulating layer may simultaneously implement the insulation function, functions of a binder, and functions of a curing agent, such that an inductor capable of having a high permeability and a high Q value may be provided without a limitation of the material used as the powder particle core.

Since a manufacturing method of the inductor is the same as a manufacturing method of a general inductor, except for forming the body, hereinafter, a formation method of the body 10 of the inductor will be mainly described.

First, a magnetic powder 1 prepared by the above-mentioned method may be prepared. The magnetic powder 1 may be composed of a powder material and an insulating layer directly coated on a surface of the powder particle core. After the prepared magnetic powder is filled in a cavity, mold clamping is performed thereon, and the magnetic powder filled in a mold cavity may be compressed. It is preferable that the magnetic powder is compressed, for example, at 5 to 20 ton/cm², so as to be suitable for molding a core. Thereafter, a molded body of the compressed magnetic powder may be picked out from the cavity and cured at a suitable temperature, for example, 100 to 300° C. After a coil is wound in a central portion of the magnetic core provided as described above and molded according to a general core assembly process, an inductor may be manufactured by connecting external electrodes and lead portions of the coil to each other.

A description overlapping the descriptions of the magnetic powder and the inductor according to exemplary embodiments, except for the previously given description, will be omitted.

As set forth above, according to exemplary embodiments, the magnetic powder and the inductor containing the same may have a high permeability and an excellent Q factor.

While exemplary embodiments have been shown and described above, it will be apparent to those skilled in the art that modifications and variations could be made without departing from the scope of the present invention as defined by the appended claims.

What is claimed is:

1. A magnetic powder comprising:
a powder particle core having magnetic properties; and
an insulating layer disposed on a surface of the powder particle core,
wherein the insulating layer contains a polymer material, and an inner surface of the insulating layer is disposed to contact the surface of the powder particle core.

2. The magnetic powder of claim 1, wherein the entire surface of the powder particle core is coated with the insulating layer, and the insulating layer is a single layer.

3. The magnetic powder of claim 1, wherein the insulating layer contains a thermosetting epoxy resin.

4. The magnetic powder of claim 1, wherein the powder particle core contains one or more selected from Fe, an Fe—Ni based alloy, an Fe—Si based alloy, an Fe—Si—Al based alloy, an Fe—Cr—Si based alloy, an Fe based amorphous alloy, an Fe based nanocrystalline alloy, a Co based amorphous alloy, an Fe—Co based alloy, an Fe—N based alloy, MnZn based ferrite, and NiZn based ferrite.

5. The magnetic powder of claim 1, wherein the insulating layer contains the polymer material in a range of 1 wt % or more to 5.0 wt % or less, based on 100 wt % of the powder particle core.

6. The magnetic powder of claim 1, wherein a distance from the surface of the powder particle core to an outer surface of the insulating layer, on a straight line extended from the center of gravity of the powder particle core to the outer surface of the powder particle, is 1.0 nm or more to 5.0 μm or less.

7. The magnetic powder of claim 1, wherein the powder particle core has a same composition in a central portion and a surface portion thereof, and the insulating layer is disposed directly on the surface portion of the powder particle core.

8. An inductor comprising:
a body including a coil; and
external electrodes disposed on an outer surface of the body,
wherein the body contains powder particle cores having magnetic properties in a matrix of a polymer material, and
the powder particle cores adjacent to each other are insulated from each other by the polymer material.

9. The inductor of claim 8, wherein the polymer material in the matrix directly contacts a surface of each powder particle core.

10. The inductor of claim 8, wherein the polymer material includes a thermosetting epoxy.

11. The inductor of claim 8, wherein a volume ratio of the the matrix of the polymer matrix is 3 vol % or more to 15 vol % or less, based on 100 vol % of the powder particle cores in the body.

12. The inductor of claim 8, wherein a central portion of each powder particle core and a surface portion of each powder particle core have the same composition as each other, and the surface portion of each powder particle core does not contain an additional inorganic layer having a different composition from the composition of the powder particle core.

13. The inductor of claim 8, wherein an entire surface of each powder particle core is coated with an insulating layer of the polymer material.

14. The inductor of claim 13, wherein each powder particle core includes only one insulating layer coated thereon.

15. The inductor of claim 8, wherein a content of a residual curing agent or residual binder, except for the polymer material contained in the matrix, is 0 wt %.

16. A magnetic powder comprising:
a powder particle core having magnetic properties, the powder particle core has a same composition in a central portion and a surface portion thereof; and
an insulating layer including a polymer material and disposed directly on a surface of the powder particle core to contact the surface portion of the powder particle core.

17. The magnetic powder of claim 16, wherein an entire surface of the powder particle core is coated with the insulating layer.

18. The magnetic powder of claim 16, wherein only one insulating layer is disposed on the powder particle core.

19. The magnetic powder of claim 16, wherein the powder particle core is free of any oxide.

20. The magnetic powder of claim 16, wherein the insulating layer has a uniform thickness on the powder particle core.
